(19) United States
(12) Patent Application Publication
(10) Pub. No.: US 2011/0191112 A1
(43) Pub. Date: Aug. 4, 2011

(54) ENCODER

(75) Inventor: Juha Petteri Ojanperä, Nokia (FI)

(73) Assignee: NOKIA CORPORATION, Espoo (FI)

(21) Appl. No.: 12/745,238

(22) PCT Filed: Nov. 27, 2007
(86) PCT No.: PCT/EP07/62912

§ 371 Date: Sep. 2, 2010

(51) Int. Cl. G10L 19/00

(52) U.S. Cl. 704/500

(57) ABSTRACT

An encoder for encoding an audio signal comprising at least two channels, the encoder configured to determine a first indicator dependent on the relative energies of a first and a second of the at least two channels for a first time period, determine at least two second indicators dependent on the relative energies of the first and the second of the at least two channels for the first time period, and generate an encoded signal comprising at least one part dependent on the first indicator and the at least two second indicators.

### FIELD OF THE INVENTION

The present invention relates to coding, and in particular, but not exclusively to speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

In some audio codecs the input signal is divided into a limited number of bands. Each of the band signals may be quantized. From the theory of psychoacoustics it is known that the highest frequencies in the spectrum are perceptually less important than the low frequencies. This in some audio codecs is reflected by a bit allocation where fewer bits are allocated to high frequency signals than low frequency signals.

Within audio signal encoding, there has been an issue on how to handle and how to process transient (in other words, fast changing) signal segments. This is particularly important with regards to multi channel, for example stereo, audio signals.

The present encoding techniques currently use multiple transform lengths. The encoding process uses a time-to-frequency domain transformation process to generate a series of coefficient values which represent the spectral energies within the samples of the transform length.

Current encoding processes use a relatively long transfer length (in other words, many samples) to generate a frequency representation which achieves high energy compaction (in other words how well the transform is able to concentrate the signal energy with respect to a transform output. When the energy compaction is high most of the energy is typically concentrated around a few transform samples which is advantageous in coding as only those samples need to be coded and the remaining samples can be discarded) and good frequency resolution. This long transfer length for a frame is used for stationary signal segments to produce high quality coding. A second transfer length, which is significantly shorter than the first, is then applied to fast changing or transient segments of the audio signal to limit the spreading of the quantisation noise. However the shorter transfer length produces a significantly poorer coding as the resolution and energy compaction of the signal is limited by the shorter transfer length.

Examples of well known transient coding schemes include S Shlien's “Guide to MPEG-1 audio standard”, IEEE transaction on broadcasting, volume 40, number 4, December 1996, pages 206 to 218, and the ISO-IEC JTC1/FC291WG11 “MPEG-1”, coding of moving pictures and associated audio for digital storage media of at up to about 1.5 Mbit/s, part 3: Audio, international standard 11172-3, ISO-IEC, 1993.

Such encoding systems furthermore are problematic in that they require a look ahead process, in other words the signal has to be delayed significantly in order to be able to decide on which of the transfer lengths are to be used as the time to frequency transformation in the encoding process. Furthermore, the use of multiple transformation lengths increases the complexity required within the encoder.

### SUMMARY OF THE INVENTION

The invention proceeds from the consideration that a two-phase detection method capable of using spectral energies for a first phase and time domain energies for a second phase may produce an improved encoding process.

Embodiments of the present invention aim to address the above problem.

There is provided according to a first aspect of the present invention an encoder for encoding an audio signal comprising at least two channels, the encoder configured to: determine a first indicator dependent on the relative energies of a first and a second of the at least two channels for a first time period; determine at least two second indicators dependent on the relative energies of the first and the second of the at least two channels for the first time period; generate a encoded signal comprising at least one part dependent on the first indicator and the at least two second indicators.

The at least two second indicators are preferably dependent on a received time domain representation of the audio signal.

The time period is preferably divided into at least two parts and each of the at least two second indicators may represent the difference energy estimate for each part of the time period.

The first indicator is preferably dependent on a frequency domain representation of the audio signal.

The encoder may further be configured to generate the frequency domain representation of the audio signal from the received time domain representation of the audio signal.

The encoder may further be configured to generate the frequency domain representation of the audio signal by transforming the received time domain representation of the audio signal, wherein the transforming comprises one of: a shifted discrete fourier transform; a modified discrete cosine transform; a discrete unitary transform.

The generated first part of the encoded signal may comprise a difference indicator indicating that at least one of the at least two second indicators differ from the first indicator.

The first indicator may indicate that one of the first and the second audio channels are dominant and the at least one of the at least two second indicators indicate that the other of the first and the second audio channels are dominant.

The encoded signal first part may further comprise a gain ratio, wherein the gain ratio comprises the ratio of the maximum of the first and the second channels energies and the minimum of the first and the second channels energies.

The encoded second part may comprise a quantized gain ratio.

The encoder may further be configured to generate a polychannel encoded signal comprising information from the at least two channels.

According to a second aspect of the invention there is provided a decoder for decoding an encoded signal configured to: detect within the encoded signal a first part comprising a difference indicator, a second part determining a gain ratio, and a third part comprising an encoded polychannel signal; decode the polychannel signal to generate at least a first and a second channel audio signal; select one of the first and the second channel audio signal dependent on the difference indicator; multiply the selected one of the first and the second channel audio signal by a gain factor dependent on the gain ratio.

The decoder is preferably configured to decode the polychannel signal to generate at least a first and a second channel audio signal for a first time period.

The decoder is preferably configured to: for a first part of the first time period: select one of the first and the second channel audio signal dependent on a first part of the difference indicator; multiply the selected one of the first and the second channel audio signal by a gain factor dependent on a first part of the gain ratio; and for a second part of the first time period: further select one of the first and the second channel audio signal dependent on a second part of the difference indicator; and further multiply the selected one of the first and the second channel audio signal by a gain factor dependent on a second part of the gain ratio.

According to a third aspect of the invention there is provided a method for encoding an audio signal comprising at least two channels, comprising: determining a first indicator dependent on the relative energies of a first and a second of the at least two channels for a first time period; determining at least two second indicators dependent on the relative energies of the first and the second of the at least two channels for the first time period; and generating a encoded signal comprising at least one part dependent on the first indicator and the at least two second indicators.

The at least two second indicators are preferably dependent on a received time domain representation of the audio signal.

The time period is preferably divided into at least two parts and each of the at least two second indicators may represent the relative energies for each part of the time period.

The first indicator is preferably dependent on a frequency domain representation of the audio signal.

The method may further comprise generating the frequency domain representation of the audio signal from the received time domain representation of the audio signal.

The method may further comprise generating the frequency domain representation of the audio signal by transforming the received time domain representation of the audio signal, wherein the transforming comprises one of: a shifted discrete fourier transform; a modified discrete cosine transform; a discrete unitary transform.

The generated first part of the encoded signal may comprise a difference indicator indicating that at least one of the at least two second indicators differ from the first indicator.

The first indicator may indicate that one of the first and the second audio channels are dominant and the at least one of the at least two second indicators may indicate that the other of the first and the second audio channels are dominant.

The encoded signal first part may further comprise a gain ratio, wherein the gain ratio may comprise the ratio of the maximum of the first and the second channels energies and the minimum of the first and the second channels energies.

The encoded second part may comprise a quantized gain ratio.

The method may further comprise generating a polychannel encoded signal comprising information from the at least two channels.

According to a fourth aspect of the present invention there is provided a method for decoding an encoded signal comprising: detecting within the encoded signal a first part comprising a difference indicator, a second part determining a gain ratio, and a third part comprising an encoded polychannel signal; decoding the polychannel signal to generate at least a first and a second channel audio signal; selecting one of the first and the second channel audio signal dependent on the difference indicator; and multiplying the selected one of the first and the second channel audio signal by a gain factor dependent on the gain ratio.

Decoding the polychannel signal may further comprise decoding the polychannel signal to generate at least a first and a second channel audio signal for a first time period.

Selecting and multiplying may further comprise: for a first part of the first time period: selecting one of the first and the second channel audio signal dependent on a first part of the difference indicator; multiplying the selected one of the first and the second channel audio signal by a gain factor dependent on a first part of the gain ratio; for a second part of the first time period: further selecting one of the first and the second channel audio signal dependent on a second part of the difference indicator; and further multiplying the selected one of the first and the second channel audio signal by a gain factor dependent on a second part of the gain ratio.

An apparatus may comprise an encoder as featured above.

An apparatus may comprise a decoder as featured above.

An electronic device may comprise an encoder as featured above.

An electronic device may comprise a decoder as featured above.

A chipset may comprise an encoder as featured above.

A chipset may comprise a decoder as featured above.

According to a fifth aspect of the present invention there is provided a computer program product configured to perform a method for encoding an audio signal comprising: determining a first indicator dependent on the relative energies of a first and a second of the at least two channels for a first time period; determining at least two second indicators dependent on the relative energies of the first and the second of the at least two channels for the first time period; and generating a encoded signal comprising at least one part dependent on the first indicator and the at least two second indicators.

According to a sixth aspect of the present invention there is provided a computer program product configured to perform a method for decoding an audio signal comprising: detecting within the encoded signal a first part comprising a difference indicator, a second part determining a gain ratio, and a third part comprising an encoded polychannel signal; decoding the polychannel signal to generate at least a first and a second channel audio signal; selecting one of the first and the second channel audio signal dependent on the difference indicator; and multiplying the selected one of the first and the second channel audio signal by a gain factor dependent on the gain ratio.

According to a seventh aspect of the present invention there is provided an encoder for encoding an audio signal comprising: signal processing means for determining a first indicator dependent on the relative energies of a first and a second of the at least two channels for a first time period; second signal processing means for determining at least two second indicators dependent on the relative energies of the first and the second of the at least two channels for the first time period; and encoding means for generating a encoded signal comprising at least one part dependent on the first indicator and the at least two second indicators.

According to an eighth aspect of the present invention there is provided a decoder for decoding an audio signal comprising: signal processing means for detecting within the encoded signal a first part comprising a difference indicator, a second part determining a gain ratio, and a third part comprising an encoded polychannel signal; decoding means for decoding the polychannel signal to generate at least a first and a second channel audio signal; switching means for selecting one of the first and the second channel audio signal dependent on the difference indicator; and second signal processing means for multiplying the selected one of the first and the second channel audio signal by a gain factor dependent on the gain ratio.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio codec system employing embodiments of the present invention;

FIG. 3 shows schematically an encoder part of the audio codec system shown in FIG. 2;

FIG. 4 shows a flow diagram illustrating the operation of an embodiment of the encoder as shown in FIG. 3 according to the present invention;

FIG. 5 shows schematically a decoder part of the audio codec system shown in FIG. 2; and

FIG. 6 shows a flow diagram illustrating the operation of an embodiment of the audio decoder as shown in FIG. 5 according to the present invention.

### DESCRIPTION OF PREFERRED EMBODIMENTS OF THE INVENTION

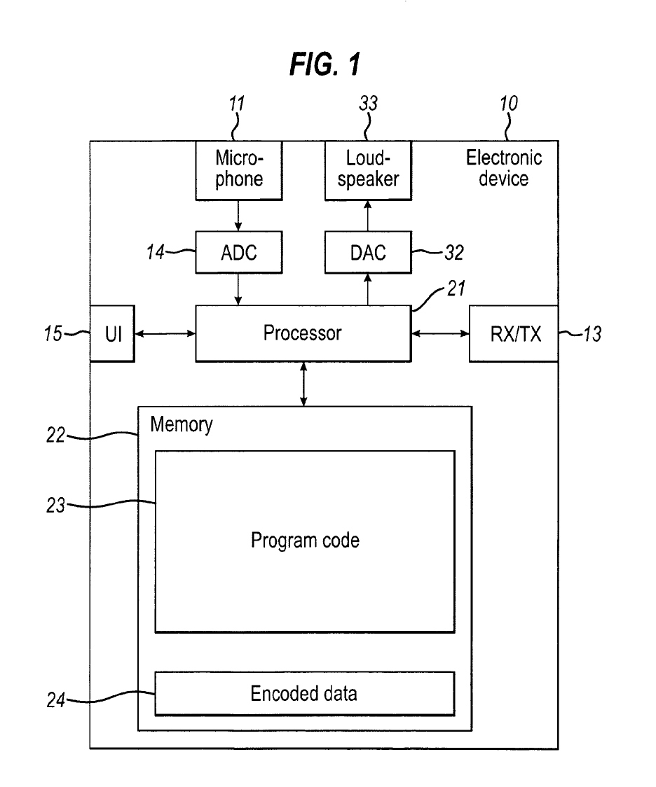

The following describes in more detail possible mechanisms for the provision of a low complexity multichannel audio coding system. In this regard reference is first made to FIG. 1 schematic block diagram of an exemplary electronic device 10, which may incorporate a codec according to an embodiment of the invention.

The electronic device 10 may for example be a mobile terminal or user equipment of a wireless communication system.

The electronic device 10 comprises a microphone 11, which is linked via an analogue-to-digital converter 14 to a processor 21. The processor 21 is further linked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes comprise an audio encoding code for encoding a combined audio signal and code to extract and encode side information pertaining to the spatial information of the multiple channels. The implemented program codes 23 further comprise an audio decoding code. The implemented program codes 23 may be stored for example in the memory 22 for retrieval by the processor 21 whenever needed. The memory 22 could further provide a section 24 for storing data, for example data that has been encoded in accordance with the invention.

The encoding and decoding code may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 converts the input analogue audio signal into a digital audio signal and provides the digital audio signal to the processor 21.

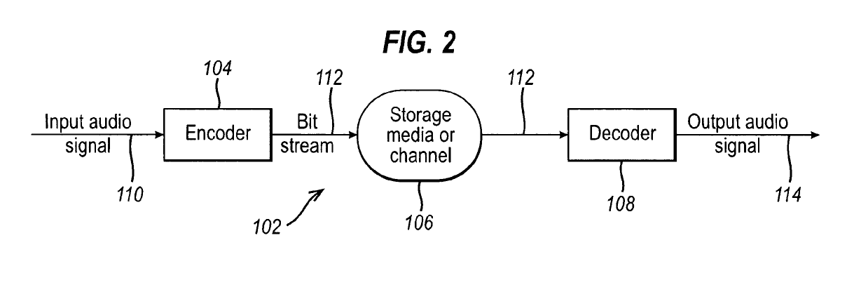

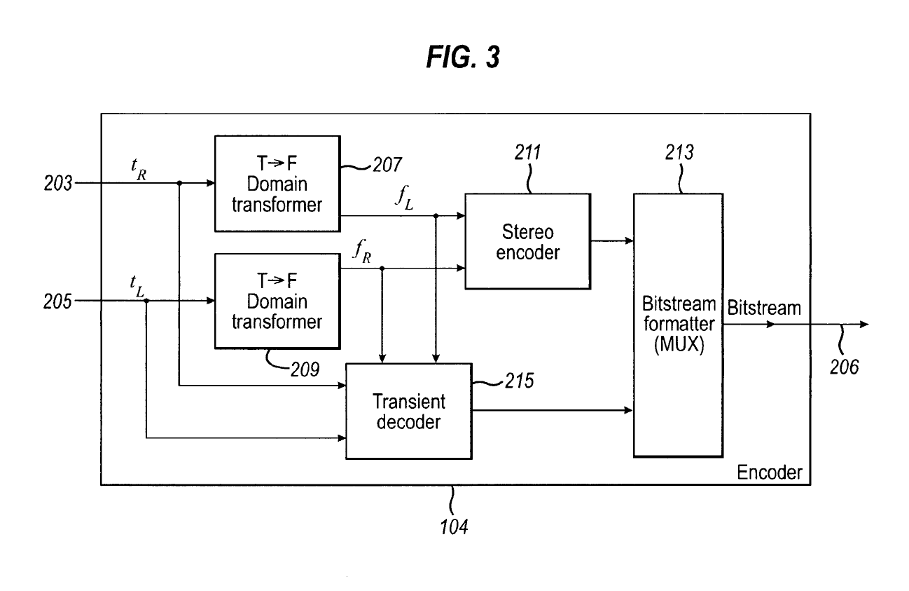

The processor 21 may then process the digital audio signal in the same way as described with reference to FIGS. 2 and 3.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 could also receive a bit stream with correspondingly encoded data from another electronic device via its transceiver 13. In this case, the processor 21 may execute the decoding program code stored in the memory 22. The processor 21 decodes the received data, and provides the decoded data to the digital-to-analogue converter 32. The digital-to-analogue converter 32 converts the digital decoded data into analogue audio data and outputs them via the loudspeakers 33. Execution of the decoding program code could be triggered as well by an application that has been called by the user via the user interface 16.

The received encoded data could also be stored instead of an immediate presentation via the loudspeakers 33 in the data section 24 of the memory 22, for instance for enabling a later presentation or a forwarding to still another electronic device.

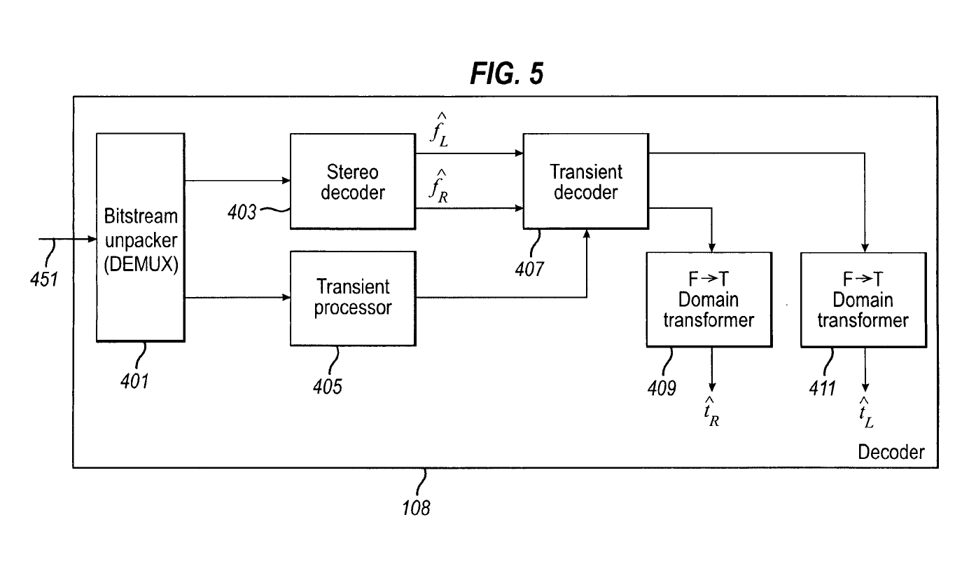

It would be appreciated that the schematic structures described in FIGS. 2, 3, 4 and 7 and the method steps in FIGS. 5, 6 and 8 represent only a part of the operation of a complete audio codec as exemplarily shown implemented in the electronic device shown in FIG. 1.

The general operation of audio codecs as employed by embodiments of the invention is shown in FIG. 2. General audio coding/decoding systems consist of an encoder and a decoder, as illustrated schematically in FIG. 2. Illustrated is a system 102 with an encoder 104, a storage or media channel 106 and a decoder 108.

The encoder 104 compresses an input audio signal 110 producing a bit stream 112, which is either stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features, which define the performance of the coding system 102.

FIG. 3 depicts schematically an encoder according to an embodiment of the invention. The encoder comprises inputs 203 and 205 which are arranged to receive an audio signal comprising two channels. The two channels may be arranged as a stereo pair comprising a left and right channel. However, it is to be understood that further embodiments of the present invention may be arranged to receive more than two input audio signal channels, for example a six-channel input arrangement may be used to receive a 5.1 surround sound audio channel configuration.

The inputs 203 and 205 are connected the left and right channel time-to-frequency domain transformers 207 and 209 respectively. Furthermore, the inputs 203 and 205 are connected to the transient coder 215. An output of the left channel time-to-frequency domain transformer 207 is connected to the stereo encoder 211 and the transient coder 215. The right channel time-to-frequency domain transformer 209 is connected the stereo encoder 211 and the transient coder 215. The stereo encoder is further connected to the bit stream formatter 213. The transient coder 215 is connected to the bit stream formatter 213. The bit stream formatter 213 outputs a bit stream 112 via the output 206.

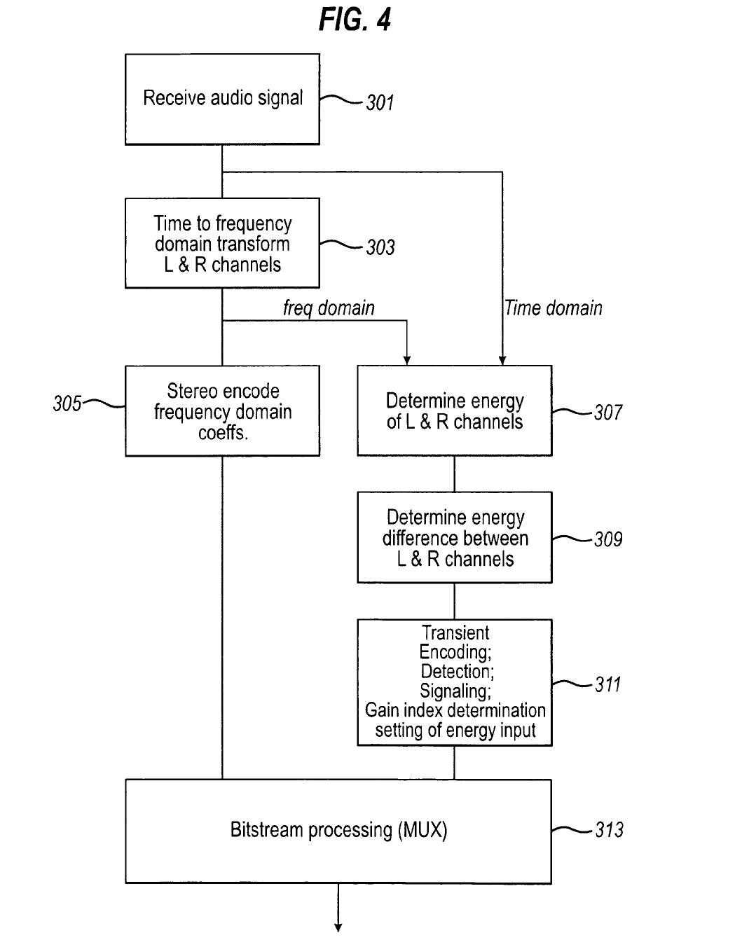

The operation of the components of the encoder 104 is described in more detail hereafter with reference to the flow chart of FIG. 4 showing the operation of the encoder 104 according to an embodiment of the invention.

The audio signal is received by the coder 104. In a first embodiment of the invention, the audio signal is a digitally sampled signal. In other embodiments of the present invention, the audio input may be an analogue audio signal, for example from a microphone 6, which is analogue-to-digitally converted (A-D). In further embodiments of the invention, the audio input is converted from a pulse modulation digital signal to an amplitude modulation digital signal.

The receiving of the audio signal is shown in FIG. 4 by step 301.

In the embodiment shown in FIG. 3, the left channel input 203 is shown to be a time domain input t_{L} which is passed to the left channel time-to-frequency domain transformer 207 and to the transient coder 215. The right channel input 205 has a time domain signal input t_{R} which is passed to the right channel time-to-frequency domain transformer 209 and to the transient coder 215.

The left and right channel time-to-frequency domain transformers 207 and 209 respectively, receive the left and right channel time domain audio signals and produce frequency domain representations at the output.

In the embodiment shown in FIG. 3, each channel is processed by a separate time-to-frequency domain transformer. However, in further embodiments of the invention, multiple channels may be processed by separate time-to-frequency domain transformers or may be processed separately and/or concurrently within a single time-to-frequency domain transformer.

In an embodiment of the invention, each time to frequency domain transformer 207, 209 operates a shifted discrete Fourier transform (SDFT) to obtain the frequency representation of the time domain audio signal according to the following equations:

f_{L}=SDFT_{N}(t_{L})

f_{R}=SDFT_{N}(t_{R})

where t_{L} and t_{R} are the left and right channel time domain signals respectively. Furthermore in an embodiment of the invention the shifted Fourier transform is carried out on a length of 2N samples of the time domain signals where consecutive analysis frames overlap by 50% to produce N complex values.

The transform SDFT_{N}( ) is a N-point SDFT transform applied to the specified input signal, and f_{L} and f_{R} represent the complex valued frequency domain spectral representations for the left and right channels respectively.

In further embodiments of the invention, the time-to-frequency domain transformers 207, 209 may output a modified discrete cosine transformation (MDCT) representation from the SDFT signal. This may be carried out using the real part of complex output from the SDFT as shown below:

f_{MDCT}_{_{L}}(i)=2·f_{L}_{ᵣₑₐₗ}(i), 0≦i<N

f_{MDCT}_{_{R}}(i)=2·f_{R}_{ᵣₑₐₗ}(i), 0≦i<N

where f_{MDCT}(i) is the MDCT representation and f_{Lreal}(i) is the real part of the SDFT output.

In further embodiments of the invention, the frequency domain representation may be generated using a discrete Fourier transform (OFT) or the time-to-frequency domain transformer 207, 209 may use an analysis filter bank structure to generate a frequency domain based representation of the signal. Examples of the analysis filter bank structures include but are not limited to quadrature mirror filter banks (QMF) and cosine modulated pseudo QMF filter banks.

The frequency domain representations of the left and right channels may further be grouped into regions or sub-bands of coefficients. The grouping into sub-bands may be dictated by a psychoacoustic model. The sub-band groupings may be fixed or variable over time. Furthermore, the sub-bands groupings within a single frame may comprise an equal number of coefficients or may comprise different numbers of coefficients.

In further embodiments of the present invention, the transformers 207 and 209 may be any suitable unitary or discrete orthogonal transformation.

The time-to-frequency domain transformation of the channels is shown in FIG. 4 by step 303.

The stereo encoder 211 receives the outputs of the time-to-frequency domain transformers 207 and 209 (in other words the spectral coefficient values representing the input audio signals). The stereo encoder 211 may encode the received coefficient values using any suitable stereo supported encoding process. Examples of suitable stereo supported encoding processes include MPEG-1 Layer III (aka MP3), and AAC (Advanced Audio Coding) encoding.

Furthermore the encoded signal may be quantized within the stereo encoder 211.

The stereo encoder 211 outputs the encoded and quantized representation of the stereo channels to the bit stream formatter 213.

The encoding of the stereo channels is shown in FIG. 4 by step 305.

The transient coder receives the left and right channel spectral coefficient values f_{L} and f_{R} from the time-to-frequency domain transformers 207 and 209, and the left and right channel time domain sample values t_{L} and t_{R} from the left and right channel inputs 203, 205.

The transient coder 215 may calculate the energy of the channels by summing the squared real and the imaginary components of the spectral coefficient values. This may be represented by the following equations:

$${E}_{{f}_{L}} = {\sum }_{i = 0}^{N - 1} {e}_{fL} ( i )$$

$${e}_{{f}_{L}} ( i ) = {{f}_{{L}_{real}} ( i )}^{2} + {{f}_{{L}_{imag}} ( i )}^{2} , 0 \leq i < N$$

$${E}_{{f}_{R}} = {\sum }_{i = 0}^{N - 1} {e}_{{f}_{R}} ( i )$$

$${e}_{{f}_{R}} ( i ) = {{f}_{{R}_{real}} ( i )}^{2} + {{f}_{{R}_{imag}} ( i )}^{2} , 0 \leq i < N$$

where E_{f} is the total energy for the channel for a specific frame, and f_{Lreal} the real part of the frequency representation of the left channel (similarly f_{Rreal} is the real part of the frequency representation of the right channel), f_{Limag} the imaginary part of the frequency domain representation of the left channel signal (similarly f_{Rimag} is the imaginary part of the frequency representation of the right channel signal) and i is a dummy variable representing the current spectral coefficient.

The determination of the energy of the left and right channels is shown in step 307.

The transient coder then examines the determined energy values for the left and right channels for a current frame. If the transient coder 215 determines that there is a significant energy difference between the left and right channels, then a transient energy check is carried out.

The transient coder 215 carries out a transient error check by determining the number of times where the energy distribution between the left and right channels in a short block is different from that determined in the frequency domain energy distribution calculation described above.

A short block represents a sub-division of the time domain frame length.

In a first embodiment of the invention, the transient coder 215 may follow the following pseudo steps to produce the ratio value:

$$phase - 1 = \{ \begin{matrix}continue , & {E}_{{f}_{L}} > 4 \cdot {E}_{{f}_{R}} or {E}_{{f}_{R}} > 4 \cdot {E}_{{f}_{L}} \\ stop , & otherwise\end{matrix} \\ if ( phase - 1 == continue ) \\ ratio ( i ) = \{ \begin{matrix}{r}_{L} ( i ) , & {E}_{{f}_{L}} > {E}_{{f}_{R}} \\ {r}_{R} ( i ) , & otherwise\end{matrix} , 0 \leq i < \frac{N}{subblock\_len}$$

The first step is the detection of whether the spectral energy level in one channel is greater than four times the spectral energy level in the other channel.

The second step is the ratio value for each sub-block is set to be the value of r_{L} where the left channel spectral energy was greater than the right channel spectral energy and the value r_{R} where the right channel spectral energy was greater than the left channel spectral energy.

Furthermore, the value r_{L} may be determined by calculating the ratio of the energy of the sub-block left channel time sample energy over the sub-block right channel time sample energy. The value r_{R} may be determined by calculating the ratio of the energy of the sub-block (i) right channel time sample energy over the sub-block (i) left channel time sample energy. This may be carried out according to the equations below:

$${r}_{L} ( i ) = \frac{{e}_{{L}_{t}}}{{e}_{{R}_{t}}} , {r}_{R} ( i ) = \frac{{e}_{{R}_{t}}}{{e}_{{L}_{t}}}$$

$${e}_{{L}_{t}} = {\sum }_{j = 0}^{subblock\_len - 1} {{t}_{L} ( N + i \cdot subblock\_len + j )}^{2}$$

$${e}_{{R}_{t}} = {\sum }_{j = 0}^{subblock\_len - 1} {{t}_{R} ( N + i \cdot subblock\_len + j )}^{2}$$

where e_{Lt} and e_{Rt} are the time domain energy values.

In the above example, the variable subblock_len is the length of the time domain sub-block. In an embodiment of the invention where the frame length N=640 which corresponds to 20 ms at a sampling rate of 32 kHz, and subblock_len=160 which corresponds to 5 ms.

The determination of the energy differences between the left and right channels between the frequency and time domain representations of the audio signal are shown in FIG. 4 by step 309.

The transient coder 215 furthermore then determines using the transient error check data whether transient encoding is to be enabled or disabled. In other words the transient coder detects and enables encoding which assists in the situation where the audio signal moves quickly from the left to the right channel or from the right to the left channel.

In an embodiment of the present invention, the transient coder 215 coding decision may be made by enabling transient coding for a frame where any of the sub-blocks indicate that the time domain sub-block energy distribution differs from the frequency domain energy distribution. In one embodiment this decision may be made by examining a count result of all sub-blocks in a frame where the energy distributions differ. This may be represented according to the following steps:

$$transient\_result = \{ \begin{matrix}transient disabled , & \begin{matrix}count == 0 or \\ phase - 1 != continue\end{matrix} \\ transient enabled , & otherwise\end{matrix} \\ count = {\sum }_{i = 0}^{N / subblock\_len - 1} \{ \begin{matrix}1 , & ratio ( i ) < 0 \\ 0 , & otherwise\end{matrix}$$

Where transient encoding is enabled the transient coder 215 may generate signalling bits to be inserted into the bitstream to indicate to the receiver that transient processing has been enabled. In further embodiments of the invention the transient coder 215 may further generate further signalling bits to indicate which of the channels is more dominant and the transient processing gain.

This information may in embodiments of the invention be generated according to the following pseudo code.

```
if(transient_result == transient_enabled)
{
  Send ‘1’ bit
  if( E_{fL} > E_{fR} )
    Send ‘1’ bit
  else
    Send ‘0’ bit
    Send transient gain index (2-bits)
}
else
  Send ‘0’ bit
```

This pseudo code operation generates a ‘1’ signalling bit to indicate where the left channel is dominant over the right channel or generates a ‘0’ signalling bit to indicate that the right channel is dominant over the left channel.

Furthermore, the generated transient gain index according to an embodiment of the invention is generated and quantized by generating a gain value, which is the maximum of the left and right channel frequency energy values divided by the minimum of the left and right channel frequency energy values. The gain value is then modified to be the minimum value of the square of the initial generated gain value subtracted by a positive or negative multiple of root 2—in other words 2^{0.5} or 2^{-0.5} or 2^{-1.5} or 2^{-2.5}. This gain index calculation may in embodiments of the invention be represented by the following steps:

$${min}_{i} ( {( gain - {2}^{0.5 \cdot i} )}^{2} ) , 0 \leq i < 4$$

$$gain = \frac{MAX ( {E}_{{f}_{L}} , {E}_{{f}_{R}} )}{MIN ( {E}_{{f}_{L}} , {E}_{{f}_{R}} )}$$

where minᵢ minimises the input samples with respect to i and MAX and MIN return the maximum and minimum of the specified samples respectively.

The transient coder also stores or transmits to the receiver side the value of i which minimises the above equation.

The transient coder 215 then transmits the transient results, in other words the indication of which of the channels is more dominant, the transient processing gain, quantization index and whether or not transient processing has been enabled to the bit stream formatter 213.

The transient encoding, the detection the signalling and gain index determination is shown in FIG. 4 by step 311.

The bit stream formatter 213 having received the stereo encoded output signal from the stereo encoder 211 and the transient coder output from the transient coder 215 multiplexes or formats the bit stream to produce the output bit stream 112 via the output 206. The bit stream processing is shown in FIG. 4 by the step 313.

FIG. 5 shows a schematic view of a decoder according to a first embodiment of the invention. The decoder 108 comprises an input 451 which is arranged to receive an encoded audio signal. The input 451 is passed to a bit stream unpacker (or demultiplexer). The bit stream unpacker 401 is arranged to output unpacked data to the stereo decoder 403 and the transient processor 405. An pair of left and right channel outputs of the stereo decoder 403 are configured to be connected to a pair of inputs at a transient decoder 407. An output of the transient processor is furthermore configured to be connected to an further input of the transient decoder 407. The transient decoder 407 is arranged to output a left channel output to the left channel frequency-to-time domain transformer 411 and a right channel output to the right frequency-to-time domain transformer 409. The left channel frequency-to-time domain transformer 411 is arranged to output a left time domain audio signal estimate. The right frequency-to-time domain transformer 409 is arranged to output a right time domain audio signal estimate.

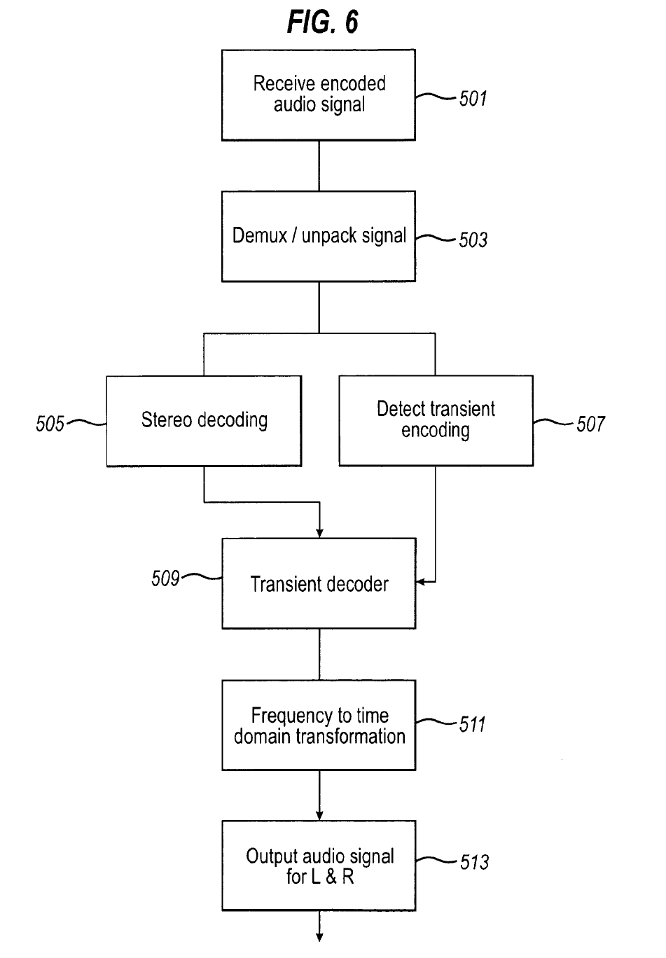

With respect to FIG. 6, the operation of the components is described in more detail showing the operation of the embodiment of the decoder 108 shown in FIG. 5.

The encoded signal is received at the encoded signal input 451 and passed to the bit stream unpacker 401.

This step of receiving the encoded audio signal is shown in FIG. 6 step 501.

The bit stream unpacker 401 demultiplexes, partitions or unpacks the encoded bit stream 112 into at least two separate bit streams. The stereo encoded bit stream is passed to the stereo decoder 403, the transient information is passed to the transient processor 405.

The demultiplexing or unpacking process is shown in FIG. 6 by step 503.

The stereo decoder 403 receiving the stereo encoded information from the bit stream unpacker 401 performs a stereo decoding process to reverse the process carried out by the stereo encoder 211 within the encoder 104. The stereo decoder therefore outputs two frequency domain representations of the left \hat{f}_{L} and right \hat{f}_{R} channels respectively.

The estimated/decoded frequency domain representations of the audio signal are then passed to the transient decoder 407.

The stereo decoding of the signal is shown in FIG. 6 by step 505.

The transient processor 405 receives the transient encoded information from the bitstream unpacker 401 and detects whether or not a signal bit has been received indicating whether transient encoding occurred.

If transient encoding occurred within the encoder 104, then the transient processor 405 reads the transient information to determine the dominant channel (chldx) and gain index value.

In some embodiments of the invention, this read information is passed directly to the transient decoder 407.

In other embodiments of the invention, the transient processor dequantizes the gain index. The gain index may be dequantized according to the complementary process to the quantization process operated in the encoder 104. Thus in embodiments of the invention the dequantization gain may be determined using the following equation:

qgain=2^{0.5·gain}^{_{—}}^{index}

where gain_index is the 2-bit value read from the bit stream.

The transient processor 405 may pass either processed or unprocessed transient data to the transient decoder.

In further embodiments of the invention, the transient processor 405 is incorporated within a transient decoder 407.

The detection of transient encoding by the coder can be shown in FIG. 6 by step 507.

The transient decoder 407 receives the frequency domain representations of the left and right channel estimates from the stereo decoder 403 and the transient information from the transient processor 405.

Where the transient processor 405 has detected that transient processing was enabled within the encoder 104 and an indication passed to the transient decoder 407 via the transient processor 405, then the decoded left and right frequency domain representations may be processed to reflect the gain values.

In an embodiment of the invention, the decoded left and right channels may be multiplied by the determined gain values dependent on whether the left or right channel is the dominant or significant channel. The process of modification within the transient decoder 407 may be according to the following steps:

$$if ( transient\_decoding \_enabled == {}_{}^{‵}{1}{}_{}^{′} bit )$$

$$if ( chIdx == {}_{}^{‵}{1}{}_{}^{′} bit )$$

$${\hat{f}}_{R} ( i ) = {\hat{f}}_{R} ( i ) \cdot \frac{1}{qgain} , 0 \leq i < N$$

$$else$$

$${\hat{f}}_{L} ( i ) = {\hat{f}}_{L} ( i ) \cdot \frac{1}{qgain} , 0 \leq i < N$$

The transient decoding and modification of the frequency representations is shown within FIG. 6 by step 509.

The transient decoder 407 outputs the frequency domain left and right channel estimated representations (either the stereo decoder versions where transient decoding was not required, or the modified version from the transient decoder where transient decoding was required).

The transient decoder left channel frequency representation is passed to the left channel frequency-to-time domain transformer 411. The right channel frequency domain representation from the transient decoder 407 is passed to the right channel frequency-to-time domain transformer 409.

The left channel frequency-to-time domain transformer 411 and the right channel frequency-to-time domain transformer 409 perform a frequency-to-time domain transformation to reverse the time-to-frequency domain transformation carried out within the encoder 104. For example, in an embodiment of the invention an inverse modified discrete cosine transform may be applied to both channels to obtain a time domain representation of the left and right channels. The reconstructed time domain signal \hat{t}_{L} and \hat{t}_{R} are then passed to the output.

The frequency-to-time domain transformation is shown in FIG. 6 by step 511.

The output of the reconstructed time domain audio signal for both the left and right channels is shown in FIG. 6 by step 513.

In embodiments of the invention as can be seen above, there are clear advantages with regards to the streamlining of the encoding process. For example, there is no requirement to delay the received signal to perform look ahead analysis. Furthermore, the resolution quality is kept high with regards to the frequency domain throughout the encoding process, where the time domain signal is used to perform the transient detection indication.

The embodiments of the invention described above describe the codec in terms of separate encoders 104 and decoders 108 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device 10, it would be appreciated that the invention as described below may be implemented as part of any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof.

For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-38. (canceled)

39. An apparatus comprising at least one processor and at least one memory including computer program code the at least one memory and the computer program code configured to, with the at least one processor, cause the apparatus at least to:
determine a first indicator dependent on a frequency domain representation of an audio signal and on the relative energies of a first and a second of at least two channels of the audio signal for a first time period;
determine at least two second indicators dependent on the relative energies of the first and the second of the at least two channels for the first time period; and
generate a encoded signal comprising at least one part dependent on the first indicator and the at least two second indicators.

40. The apparatus as claimed in claim 39, wherein the at least two second indicators are dependent on a received time domain representation of the audio signal.

41. The apparatus as claimed in claim 40, wherein the time period is divided into at least two parts and each of the at least two second indicators represent the difference energy estimate for each part of the time period.

42. The apparatus as claimed in claim 41 when dependent on claim 2, wherein the at least one memory and the computer program code are further configured to, with the at least one processor, cause the apparatus at least to:
generate the frequency domain representation of the audio signal from the received time domain representation of the audio signal.

43. The apparatus as claimed in claim 42, wherein the at least one memory and the computer program code are further configured to, with the at least one processor, cause the apparatus at least to:
generate the frequency domain representation of the audio signal by transforming the received time domain representation of the audio signal, wherein the transforming comprises one of:
a shifted discrete fourier transform;
a modified discrete cosine transform;
a discrete unitary transform.

44. The apparatus as claimed in claim 39, wherein the generated first part of the encoded signal comprises a difference indicator indicating that at least one of the at least two second indicators differ from the first indicator, and wherein the first indicator indicates that one of the first and the second audio channels are dominant and the at least one of the at least two second indicators indicate that the other of the first and the second audio channels are dominant.

45. The apparatus as claimed in claim 39, wherein the encoded signal first part further comprises a gain ratio, wherein the gain ratio comprises the ratio of the maximum of the first and the second channels energies and the minimum of the first and the second channels energies, and wherein the encoded second part comprises a quantized gain ratio.

46. The apparatus as claimed in claim 39, wherein the at least one memory and the computer program code are further configured to, with the at least one processor, cause the apparatus at least to:
generate a polychannel encoded signal comprising information from the at least two channels.

47. An apparatus comprising at least one processor and at least one memory including computer program code the at least one memory and the computer program code configured to, with the at least one processor, cause the apparatus at least to:
detect within the encoded signal a first part comprising a difference indicator, a second part determining a gain ratio, and a third part comprising an encoded polychannel signal;
decode the polychannel signal to generate at least a first and a second channel audio signal;
select one of the first and the second channel audio signal dependent on the difference indicator;
multiply the selected one of the first and the second channel audio signal by a gain factor dependent on the gain ratio.

48. The apparatus as claimed in claim 47, wherein the at least one memory and the computer program code are further configured to, with the at least one processor, cause the apparatus at least to:
decode the polychannel signal to generate at least a first and a second channel audio signal for a first time period.

49. The apparatus as claimed in claim 47, wherein the at least one memory and the computer program code are further configured to, with the at least one processor, cause the apparatus at least to:
for a first part of the first time period:
select one of the first and the second channel audio signal dependent on a first part of the difference indicator;
multiply the selected one of the first and the second channel audio signal by a gain factor dependent on a first part of the gain ratio;
for a second part of the first time period:
further select one of the first and the second channel audio signal dependent on a second part of the difference indicator; and
further multiply the selected one of the first and the second channel audio signal by a gain factor dependent on a second part of the gain ratio.

50. A method comprising at least two channels, comprising:
determining a first indicator dependent on a frequency domain representation of an audio signal and on the relative energies of a first and a second of at least two channels of the audio signal for a first time period;
determining at least two second indicators dependent on the relative energies of the first and the second of the at least two channels for the first time period; and
generating a encoded signal comprising at least one part dependent on the first indicator and the at least two second indicators.

51. The method as claimed in claim 50, wherein the at least two second indicators are dependent on a received time domain representation of the audio signal.

52. The method as claimed in claim 51, wherein the time period is divided into at least two parts and each of the at least two second indicators represent the relative energies for each part of the time period.

53. The method as claimed in claim 52, further comprising generating the frequency domain representation of the audio signal from the received time domain representation of the audio signal.

54. The method as claimed in claim 53, further comprising generating the frequency domain representation of the audio signal by transforming the received time domain representation of the audio signal, wherein the transforming comprises one of:
a shifted discrete fourier transform;
a modified discrete cosine transform;
a discrete unitary transform.

55. The method as claimed in claim 49 wherein the generated first part of the encoded signal comprises a difference indicator indicating that at least one of the at least two second indicators differ from the first indicator, and wherein the first indicator indicating that one of the first and the second audio channels are dominant and the at least one of the at least two second indicators indicating that the other of the first and the second audio channels are dominant.

56. The method as claimed in claim 49, wherein the encoded signal first part further comprises a gain ratio, wherein the gain ratio comprises the ratio of the maximum of the first and the second channels energies and the minimum of the first and the second channels energies, and wherein the encoded second part comprises a quantized gain ratio.

57. The method as claimed in claim 49, further comprising generating a polychannel encoded signal comprising information from the at least two channels.

58. A method comprising:
detecting within the encoded signal a first part comprising a difference indicator, a second part determining a gain ratio, and a third part comprising an encoded polychannel signal;
decoding the polychannel signal to generate at least a first and a second channel audio signal;
selecting one of the first and the second channel audio signal dependent on the difference indicator; and
multiplying the selected one of the first and the second channel audio signal by a gain factor dependent on the gain ratio.

59. The method as claimed in claim 58, wherein decoding the polychannel signal further comprises decoding the polychannel signal to generate at least a first and a second channel audio signal for a first time period.

60. The method as claimed in claim 59, wherein selecting and multiplying further comprises:
for a first part of the first time period:
selecting one of the first and the second channel audio signal dependent on a first part of the difference indicator;
multiplying the selected one of the first and the second channel audio signal by a gain factor dependent on a first part of the gain ratio;
for a second part of the first time period:
further selecting one of the first and the second channel audio signal dependent on a second part of the difference indicator; and
further multiplying the selected one of the first and the second channel audio signal by a gain factor dependent on a second part of the gain ratio.

61. A computer program product comprising computer readable medium bearing computer program code embodied therein for use with a computer, the computer program code comprising instructions operable to cause a processor to:
determine a first indicator dependent on a frequency domain representation of an audio signal and on the relative energies of a first and a second of the at least two channels of the audio signal for a first time period;
determine at least two second indicators dependent on the relative energies of the first and the second of the at least two channels for the first time period; and
generate an encoded signal comprising at least one part dependent on the first indicator and the at least two second indicators.

62. A computer program product comprising computer readable medium bearing computer program code embodied therein for use with a computer, the computer program code comprising instructions operable to cause a processor to:
detect within the encoded signal a first part comprising a difference indicator, a second part determining a gain ratio, and a third part comprising an encoded polychannel signal;
decode the polychannel signal to generate at least a first and a second channel audio signal;
select one of the first and the second channel audio signal dependent on the difference indicator; and
multiply the selected one of the first and the second channel audio signal by a gain factor dependent on the gain ratio.
